(19) United States
(12) Patent Application Publication
(10) Pub. No.: US 2010/0198613 A1
(43) Pub. Date: Aug. 5, 2010

(54) Computer System

(75) Inventors: Peter Richard Weller, London (GB); Qi Ma, London (GB)

Correspondence Address: MODERN TIMES LEGAL, ONE BROADWAY , 14TH FLOOR, CAMBRIDGE, MA, 02142, US

(73) Assignee: CITY UNIVERSITY, London (GB)

(21) Appl. No.: 12/670,450

(22) PCT Filed: Jul. 28, 2008
(86) PCT No.: PCT/GB08/02584

§ 371 Date: Jan. 25, 2010

(30) Foreign Application Priority Data
Jul. 26, 2007 (GB) 0714514.7

(51) Int. Cl. G06Q 50/00; G06F 13/42

(52) U.S. Cl. 705/2; 710/106

(57) ABSTRACT

A computer system (1) comprising: a system hub (11) configured to receive data signals from one or more items of equipment (13, 15), and to generate signals for transmission to a wearable computer (3) from said received data signals; a wearable display (5); and a wearable computer (3) configured to receive the signals transmitted from said system hub (11), and to display on said wearable display (5) information relating to the signals received from said system hub (11).

### FIELD OF THE INVENTION

This invention relates to computer systems, particularly but not exclusively to computer systems for use in a hospital environment. In one particularly preferred illustrative embodiment the invention relates to a computer system for monitoring patient wellbeing in a hospital environment.

The teachings of the present invention will hereinafter be described with particular reference to a hospital environment, and in particular to use of the computer system in a hospital environment. It should be remembered, however, that this application is merely illustrative and that the teachings of the present invention may be employed in a variety of different applications.

### BACKGROUND TO THE INVENTION

In a modern hospital environment, any given clinician is typically charged with caring for a plurality of patients. Those patients are often connected to monitoring equipment, and this equipment is configured so that in the event that the condition of one or more of those patients should deteriorate to such an extent that an emergency occurs, the monitoring equipment will activate an alarm.

If the clinician should be in the vicinity of the patient when an alarm activates, then the clinician can quickly attend to the patient's needs. If, as is often the case, the clinician is not in the immediate vicinity of the patient (for example because the clinician is operating at the time, or is in another part of the hospital), it is conventional for one of the nursing staff to page the clinician (often known as bleeping the clinician), whereupon the clinician receives a message at their pager instructing them to call a particular extension so that they can speak with the nursing staff who are in the vicinity of the patient in question.

Whilst this system tends to work well in most circumstances, there are problems associated with it. For example, if the clinician should be unable to answer the page—because they are busy treating another patient for example—delays can occur in determining the best way to respond to the emergency at hand. Even if the clinician should be free to answer the page it inevitably takes time for the nursing staff to determine that an emergency has occurred, to determine the type of emergency, for the clinician to be paged, and for the clinician to answer the page.

Another problem is that when the clinician answers a page they will typically only have to hand the information provided by the nursing staff and whatever information they can remember from the patient's notes.

Yet another problem with such a system is that a clinician charged with caring for a given group of patients is only advised when an emergency has occurred. As such it is very difficult for the clinician to keep a “weather eye” on the condition of the patients under their care without repeatedly contacting the nursing staff to get updates on the condition of the patients in their care.

The present invention seeks to address these problems.

### SUMMARY OF THE INVENTION

To this end, a presently preferred embodiment of the present invention provides a computer system comprising: a system hub configured to receive data signals from one or more items of equipment, and to generate signals for transmission to a wearable computer from said received data signals; a wearable display; and a wearable computer configured to receive the signals transmitted from said system hub, and to display on said display information relating to the signals received from said system hub.

An advantage of this embodiment is that the display of information on a wearable computer provides the person wearing that computer with a ready means to appreciate, for example, the current status of the items of equipment. When applied to a hospital environment, clinicians wearing a wearable computer will more easily be able to keep a weather eye on their patients, and be more quickly notified in the event of a problem.

Another embodiment of the present invention relates to a method comprising: operating one or more items of equipment to generate data signals; transmitting said data signals to a system hub that is configured to receive said data signals, and from said received data signals to generate signals for transmission to a wearable computer; and operating a wearable computer to receive the signals transmitted from said system hub, and to generate from said signals transmitted from said system hub information for display on a wearable display that relates to the signals received from said system hub.

Another embodiment of the present invention provides a computer program comprising one or more software modules configured to implement one or more of the steps of the method herein described.

Yet another embodiment of the invention relates to a computer program comprising: one or more software modules executable by a system hub, for example a system hub of a computer system as described herein, to receive data signals transmitted from one or more items of equipment, and from said received data signals to generate signals for transmission to a wearable computer; the wearable computer being operable to receive the signals transmitted from said system hub, and to generate from said signals transmitted from said system hub information for display on a wearable display, wherein the information for display on said wearable display relates to the signals received from said system hub.

Another embodiment relates to a computer program comprising: one or more software modules executable by a wearable computer, for example a wearable computer of a computer system as described herein, to receive signals transmitted from a system hub, and to generate from said signals transmitted from said system hub information for display on a wearable display, wherein the signals transmitted from said system hub relate to signals received by the system hub from one or more items of equipment.

Yet another embodiment relates to a suite of computer programs comprising: one or more software modules executable by a system hub of a computer system to receive data signals transmitted from one or more items of equipment, and from said received data signals to generate signals for transmission to a wearable computer; and one or more software modules executable by a wearable computer of said computer system to receive the signals transmitted from said system hub, and to generate from said transmitted signals information for display on a wearable display.

Particularly preferred features of each of these embodiments are set out in the accompanying claims, but the scope of each of these embodiments extends to encompass any combination or permutation of features that are explicitly or implicitly herein described.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic representation of a computer system according to a preferred embodiment of the present invention;

FIG. 2 is a schematic representation of an illustrative system hub for use with the system of FIG. 1;

FIG. 3 is a schematic representation of an illustrative wearable computer, an illustrative wearable control interface and an illustrative wearable display according to a preferred embodiment of the present invention;

FIG. 4 is a perspective view of an illustrative wearable computer;

FIG. 5 is a perspective view of an illustrative display mounted on a pair of glasses;

FIG. 6 is a first illustrative arrangement of system hub and patient monitoring equipment;

FIG. 7 is a second illustrative arrangement of system hub and patient monitoring equipment;

FIG. 8 is a representative captured image of a display of patient monitoring equipment;

FIG. 9 is a third illustrative arrangement of system hub and patient monitoring apparatus;

FIG. 10a is a schematic representation of a previously proposed data transmission schema;

FIG. 10b is a schematic representation of an alternative data transmission schema;

FIGS. 11a to 11d are schematic representations of illustrative images displayed on a wearable display;

FIGS. 12a to 12e are schematic representations of illustrative images displayed on a wearable display;

FIG. 13 is a schematic representation of the software employed by the system hub;

FIG. 14 is a schematic representation of the software employed by the wearable computer; and

FIGS. 15 and 16 are flow diagrams providing an overview of the operation of the system according to a preferred embodiment of the present invention.

### DETAILED DESCRIPTION OF PREFERRED EMBODIMENTS

Preferred embodiments of the present invention will now be described with particular illustrative reference to a computer system configured for use in a hospital environment. Whilst the teachings of the present invention are particular useful in such a configuration, the teachings of the invention have many applications and as such the scope of the present invention should not be interpreted as being limited only to the particular illustrative application hereinafter described.

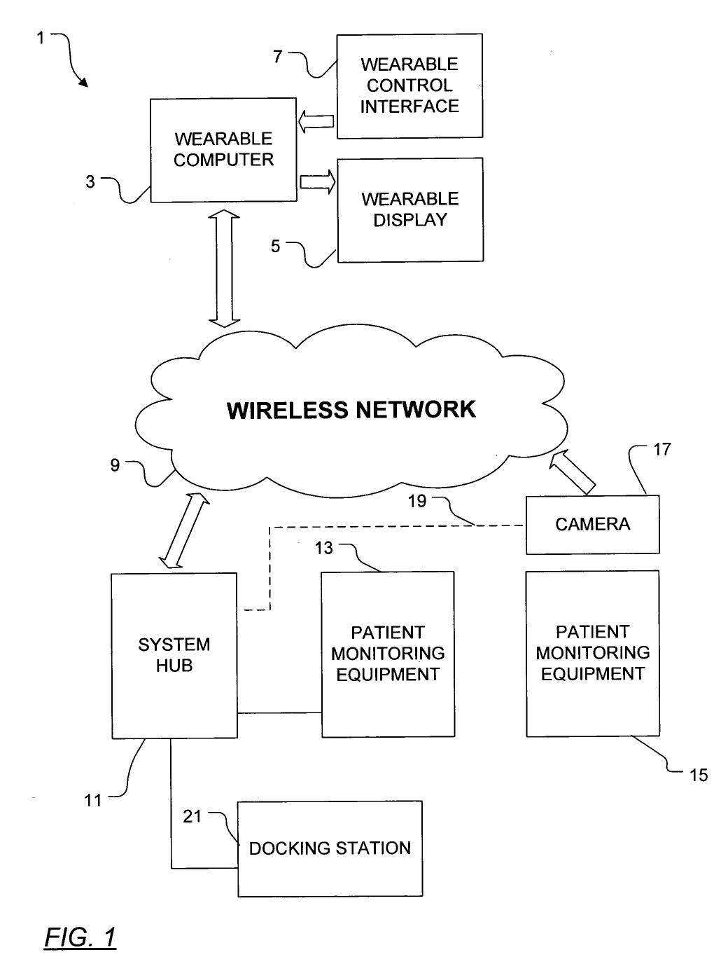

With this proviso in mind, reference is now made to FIG. 1 wherein a schematic representation of a computer system 1 in accordance with a preferred embodiment of the present invention is shown.

As shown, the computer system 1 of this embodiment comprises a wearable computer 3 (the configuration of which will later be described) that is configured to interface with a wearable display 5 and a wearable control interface 7 that is user operable to control the wearable computer 3. The wearable computer, display and control interface can be configured to communicate with one another by means of a short-range radio communications link (such as a Bluetooth™ link). In an alternative preferred configuration, the wearable computer, display and control interface may be coupled together for communication by wired links. In another arrangement the computer display and control interface may be coupled together for communication by a combination of wired and wireless links.

The wearable computer 3 comprises a wireless network interface (such as a conventional wireless LAN (local area network) interface compliant with 802.x communications standards, for example 802.11g) to permit the computer to interface with a wireless network 9 for the receipt of signals from the network and the transmission of signals to the network.

As will later be described, in the preferred embodiment the wearable display 5 comprises a head mounted display that is configured to be coupled to the arm of a pair of glasses, for example to a pair of prescription spectacles or to a pair of safety glasses.

The display includes a small relatively low resolution display that is configured to display information at the periphery of the wearer's field of vision. In this way the wearer can appreciate when changes to the information displayed on the display occur without obscuring a large part of their normal field of view. In another arrangement, the wearable display 5 could comprise a flexible display unit incorporated into an item of clothing—for example into the sleeve of a set of scrubs.

The wearable control interface 7 may take many different forms, but in a particularly preferred embodiment it comprises a track ball pointing device that is configured to be mounted in the vicinity of the user's hip, for example to their belt, so that it can readily be operated with one hand. In another envisaged implementation the control interface may include a keypad that is configured to be attached to the user's forearm. It has been found, however, that in most instances a keypad is not necessary and that a track ball or other similar pointing device suffices to enable the wearable computer to be controlled.

In the envisaged implementation each clinician will be provided with a wearable computer and as such the computer system as a whole will typically comprise a plurality of wearable computers and displays. For convenience in FIG. 1 only a single wearable computer and display has been shown. In the context of the present application, a computer, display or user interface is wearable if it is of such a size that it is readily portable by a user and does not need to be coupled to a mains power supply to operate. In an illustrative embodiment where the computer, display and interface communicate wirelessly, they may each include a battery pack (preferably a rechargeable battery pack) that powers the respective components without being coupled to a mains power supply. In another arrangement, two or more components may be wired together, one of those components may include a battery pack, and the other components may be configured to draw power from the component with the battery pack.

The computer system 1 further comprises a system hub 11 that is configured, in the preferred embodiment, as a server. As will later be described the hub 11 comprises a wireless network interface to permit the hub to communicate wirelessly with the wireless network 9 for the receipt of signals therefrom and the transmission of signals thereto. The wireless interface may be included as part of the hub, or may be provided as part of a standalone device (such as a wireless router) coupled to hub, for example by an Ethernet connection. The hub 11 includes a wired interface (such as a conventional local area network (LAN) Ethernet interface) to enable the hub to receive signals directly from patient monitoring equipment 13 that is provided with a digital output interface (e.g. a LAN Ethernet network interface) that enables the direct output of digital data from the equipment. In general terms, most modern devices include such an interface, but some legacy equipment may not.

To provide for coupling of legacy patient monitoring equipment 15 to the system hub, a preferred embodiment of the present invention provides a camera 17, for example a webcam, that is configured to communicate with the system hub by means of a direct (e.g. Ethernet) network connection 19 or more preferably via the wireless network 9. In a particularly preferred embodiment the camera 17 is coupled to a local computer (not shown) that communicates with the hub 11 by means of a direct network connection 19 (e.g. Ethernet) or via the wireless network 9. In another arrangement, the camera 17 may comprise a wireless LAN web-camera that is capable of broadcasting a video stream directly to the wireless network.

In the preferred embodiment the camera is capable of capturing video, but it will be appreciated by persons skilled in the art that a video camera could be replaced with a camera that is configured to capture still images at suitable intervals.

An illustrative example of patient monitoring equipment is the Datex-Ohmeda range of Patient Monitors provided by GE Healthcare, a division of General Electric Company.

As shown in FIG. 1, the system further comprises a docking station 21 with which the wearable computer 3 (or indeed a plurality of wearable computers) can be docked to recharge batteries of the wearable computer 3 or to transfer data, for example from storage of the system hub 11, for storage in the wearable computer 3.

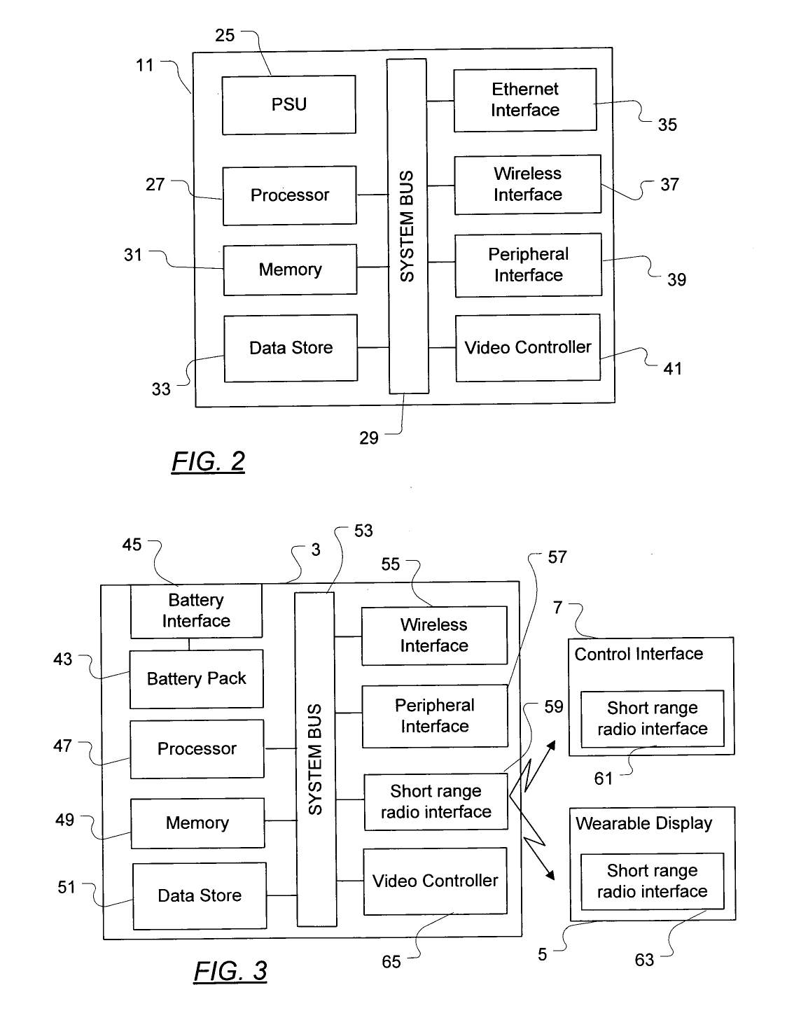

FIG. 2 is a schematic representation of a system hub according to a preferred embodiment of the present invention. The system hub 11 comprises a power supply unit 25 that is configured to draw power from a mains power supply and regulate the supply of power to the remaining components of the hub. The hub 11 includes a processor 27 that is coupled to a system bus 29 by means of which signals can be sent between the processor and the other components of the hub. The hub 11 further comprises read only memory (ROM) and/or random access memory (RAM) 31 that provides a processing environment in which the processor 27 can execute computer programs. The hub also includes a data store 33 for the storage of computer programs for execution by the processor, and in a preferred embodiment for the storage of a database of patient details and information (such as patient vitals, test results etc) associated with the patients whose details are stored in the database. The data store may comprise one or more hard disk drives (HDDs), and in a particularly preferred embodiment comprises a plurality of hard disk drives configured as a RAID (Redundant Array of Inexpensive Disks) to provide redundancy in the event that one or more drives of the array should fail. In a particularly preferred arrangement, the processor and data store are configured to automatically encrypt all data stored in the data store so that the data (much of which comprises confidential patient information) cannot easily be extracted by nefarious third parties.

In this illustrative embodiment, the system bus 29 is coupled to an Ethernet interface 35, a wireless interface 37, a peripheral interface 39 and a video controller 41. The Ethernet interface is configured to provide, as earlier described, a network connection between the hub 11 and other components of the computer system 1—such as Ethernet enabled patient monitoring equipment 13 and (optionally) a camera 17. The wireless interface is, as mentioned above, configured to enable the hub to interface with a wireless network 9 for the receipt and transmission of signals from and to the wireless network. The wireless interface could be incorporated, as illustrated, into the hub 11 or in another embodiment the wireless interface could comprise stand-alone wireless transceiver equipment coupled to the hub, for example, by an Ethernet connection.

The peripheral interface 39 is configured to enable user interface devices, such as a keyboard and/or pointing device (such as a mouse or trackball), and ancillary equipment such as one or more printers to be connected to the hub for use therewith. The peripheral interface could include RS232 connectors, USB connectors, PS2 connectors or any other type of connector. The video controller 41 provides an interface that enables a display, not shown, to be coupled to the hub, and functions in response to signals from the processor to generate images for display on the display.

FIG. 3 is a schematic representation of the wearable computer, display and user interface according to a preferred embodiment of the present invention. The wearable computer 3 comprises a battery pack 43, preferably a rechargeable battery pack that can be recharged by means for an external interface 45 that—in the preferred arrangement—is configured to mate with a complementary interface provided as part of the docking station 21. As mentioned above, the battery pack 43 is configured to power the components of the wearable computer 3, and if the wearable control interface 7 and display 5 are wired to the wearable computer 3 then these components may also draw power from the battery pack 43. In an alternative arrangement, the control interface and wearable display may include their own sources of power, for example battery packs.

The wearable computer 3 further comprises a processor 47 that is configured to execute, in an execution environment provided by memory 49, software stored in a data store 51. The data store may comprise a hard disk drive or, in a preferred embodiment, it may comprise comprises a small form factor data storage device such as a Microdrive™ or a solid state storage device (such as SDRAM or similar). In a particularly preferred embodiment the processor is configured to execute speech recognition software that allows a user to control the wearable computer purely by speaking to it, and in this embodiment the computer 3 or wearable display 5 may comprise a microphone (not shown) for the input of speech.

The processor, memory and data store are coupled to a system bus 53 that enables signals to pass between the components of the wearable computer 3. The system bus 53 is coupled to a wireless interface 55 that is configured to permit the computer to interface with a wireless network, for example the wireless network 9; and to a peripheral interface 57 that enables the wearable computer to be connected to external equipment such as a printer. The peripheral interface could include RS232 ports, USB ports, FireWire™ ports, PS2 ports, parallel ports or any other type of connector interface, and in a preferred arrangement at least part of the peripheral interface is configured and arranged so that it mates with a complementary connector provided on the docking station 21 when the wearable computer power interface 45 is coupled to the power interface of the docking station 21.

In an envisaged embodiment the system bus 53 may be connected to a short-range wireless interface 59 (such as a Bluetooth™ interface) that is configured to enable short-range wireless communications with complementary interfaces 61, 63 of the control interface 7 and display 5. In an alternative arrangement the wearable computer, wearable display and control interface may be coupled together by a wired connection.

The system bus is connected to a video controller 65 that is controlled by the processor 47 to generate images for display on the display 5, signals enabling the display of those images being transmitted (in this embodiment) via the aforementioned short range radio interface 59.

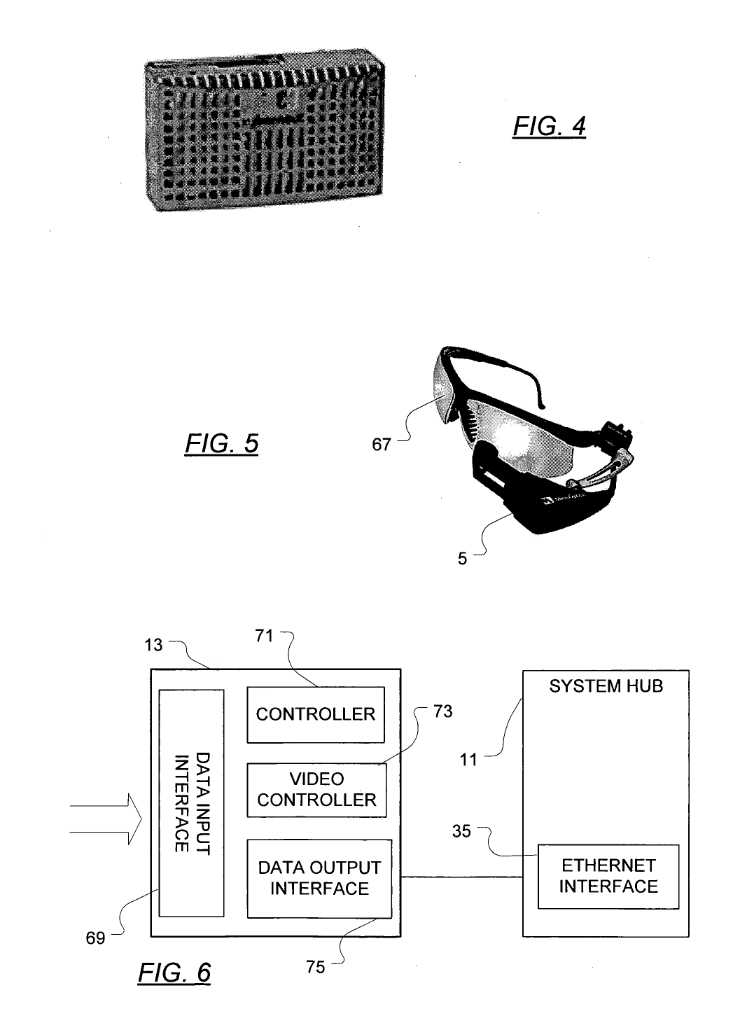

Referring now to FIG. 4 of the accompanying drawings, there is depicted an illustrative wearable computer for use with the system of the preferred embodiment. This illustrative wearable computer comprises a Xybernaut Mobile Assistant V (MAV), manufactured by Xybernaut Corporation of 5175 Parkstone Drive, Suite 130, Chantilly, Va. 20151-3832, USA. This wearable computer includes a 500 MHz Intel Mobile Celeron, 1.1 V Ultra Low Voltage Processor; 128 MB SDRAM or 256 MB memory; a 5 GB internal HDD; 1 Type II or III PCMCIA card slot, a USB interface, a FireWire (IEEE1394) port, a VGA port and a power supply interface. The wearable computer is approximately 150 mm long, 90 mm wide and 50 mm deep, and weighs approximately 455 g. Other wearable computers with equivalent (and in some instances better) performance are available.

Referring now to FIG. 5 of the accompanying drawings, there is depicted an illustrative wearable display that comprises, in this embodiment, a head mounted display. The head mounted display of this embodiment comprises a Microoptical CV-6 LCD display (produced by The MicroOptical Corporation, 33 Southwest Park, Westwood, Mass. 02090, USA), but other suitable devices will be apparent to persons skilled in the art. The SV-6 display provides enhanced colour depth of 18 bits (262,144 colours) with lightweight optics and packaging. The display mounts to safety eyewear or to conventional eyewear using a quick “mount and dismount” system, has a built-in focus mechanism, and can be used for left or right eye viewing. The display provides a 20° diagonal field of view (10 by 13 mm) at a 640×480 resolution, and weighs only 35 g. The display is compatible with most computers and instruments that provide a VGA signal at 60 Hz. As shown in FIG. 5, the wearable display 5 is shown coupled to one arm a pair of safety glasses 67 so that the user views images on the display through their left eye.

Referring now to FIG. 6, there is depicted an illustrative arrangement of system hub 11 and patient monitoring apparatus 13. In this arrangement, the patient monitoring equipment 13 comprises an input data interface 69 that is configured for coupling to one or more sensors (such as heart rate sensors, blood pressure sensors, O₂ saturation sensors, airway pressure sensors and others) that are placed on a patient's body to enable readings to be taken of the patient's vitals. The apparatus further comprises a controller 71 that controls the manner in which the apparatus operates, and a video controller 73 that is configured to generate images for display on a display (not shown) that are representative of the patient vitals being monitored. The controller 71 is coupled to a user interface (not shown) that allows a user, typically a clinician, to control the way in which measurements are taken, and in accordance with previously proposed techniques to set thresholds that cause an alarm to be sounded if transgressed. The apparatus of this arrangement also includes a digital data output interface 75, in this instance an Ethernet interface, that is directly coupled by a wired (e.g. Ethernet) link to a data input interface (in this instance the Ethernet interface 35) of the system hub 11.

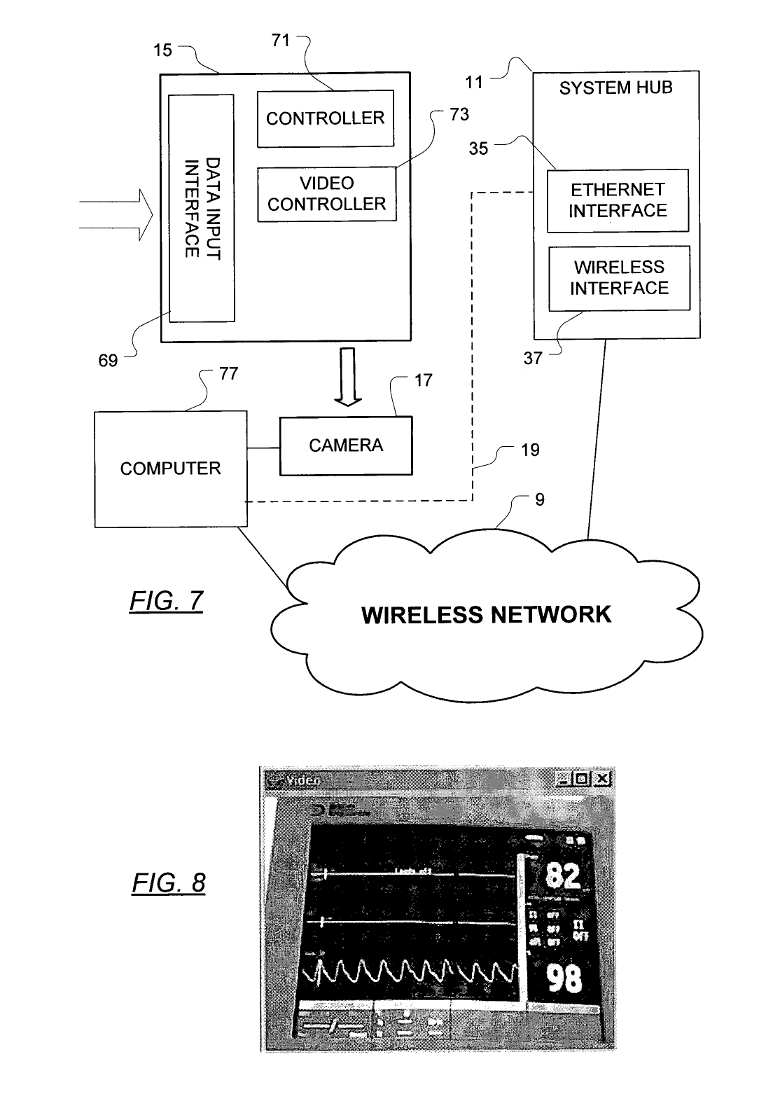

The apparatus 13 depicted in FIG. 7 differs from that in FIG. 6 in that it comprises legacy patient monitoring equipment 15 that does not include a digital data output interface by means of which signals can be output directly to the system hub 11. In this embodiment a camera 17 is trained on the display (not shown) to which the video controller 73 outputs images for display that are representative of the patient vitals being monitored. FIG. 8 is a representation of a video image captured by the camera 17.

The camera 17 is coupled to a computer 77, such as a conventional personal computer, that is coupled via the wireless network 9 to the wireless interface 37 of the system hub 11, or directly to the Ethernet interface of system hub 11 by means of an Ethernet connection 19.

The computer 77 is configured to execute software that enables a user to select one or more regions of the video image to monitor. Once the user has selected one or more areas, such as a region including the heart rate measurement (in this instance 82 bpm) depicted in the top right hand corner of the image, the computer filters out all unselected regions of the image and invokes known character recognition software to recognise—for each frame of the image—the characters being displayed in that region, and outputs to the system hub, for each frame, a signal indicative of the digits displayed on the screen of the patient monitoring equipment. The system hub 11, in a manner that will later be described, then further processes the signals from the patient monitoring apparatus 13.

The software may also allow a user to select regions of the display, such as the ECG trace shown in the bottom left hand corner of FIG. 8, that are not subjected to character recognition and are instead streamed directly to the system hub 11 for storage in the hub data store 33.

In a particularly preferred arrangement a copy of all data transferred from the patient monitoring equipment 13 is stored in the data store 33 of the system hub to provide a historical record of the patient's vitals.

In an alternative arrangement to that described above, the software that enables a user to choose one or more regions of the video frames could be executed by the system hub, in which case the video stream would be transferred substantially unmodified to the hub from the computer 77. This alternative arrangement is, however, less preferred as it would require greater amounts of data to be transferred between the computer 77 and system hub 11.

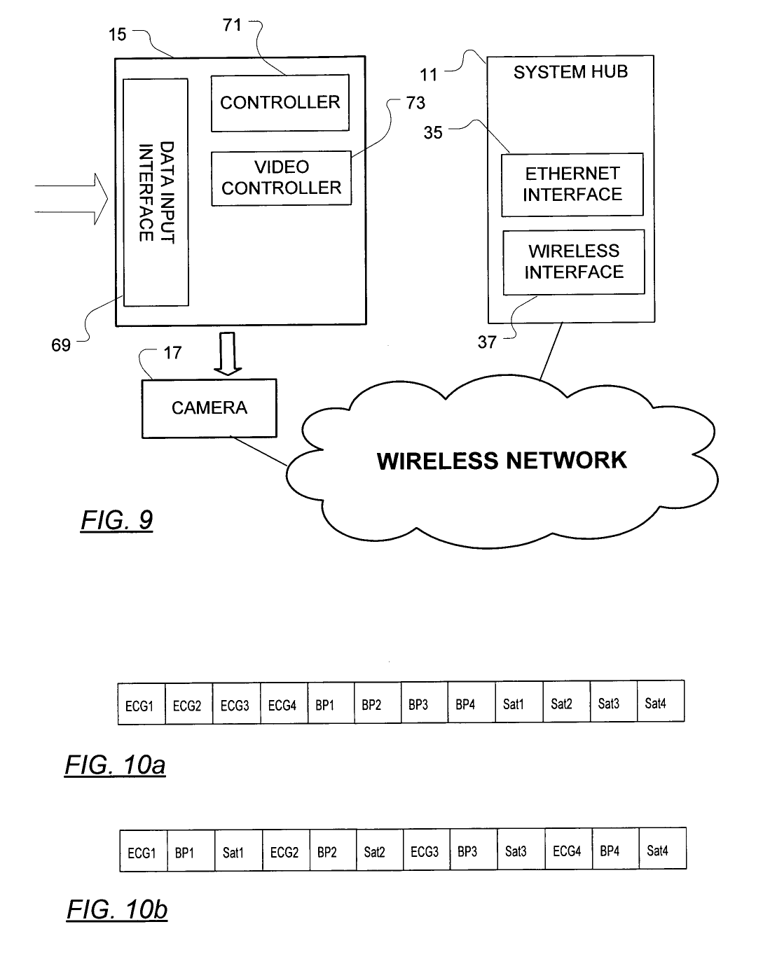

FIG. 9 is a third illustrative arrangement of system hub and legacy patient monitoring apparatus 15. In this instance, the camera 17 includes a wireless LAN interface and is configured to output a stream of video frames to the server for processing in the manner previously described. In an alternative arrangement the camera 17 could comprise an Ethernet LAN interface and be configured to pass the video frames to the system hub 11 by a wired Ethernet connection.

In conventional patient monitoring equipment that is configured to monitor a number of variables it is usual for the equipment to take measurements at predetermined intervals (for example several per second, say 10 per second) and output data representative of a number of consecutive measurements for a given variable before moving to the next variable. For example, as shown in FIG. 10a, in equipment monitoring an ECG output, blood pressure and O₂ saturation, the equipment may be configured to output four consecutive ECG measurements (ECG1 . . . ECG4), followed by four consecutive blood pressure measurements (BP1 . . . BP4), and then four consecutive O₂ saturation measurements (Sat1 . . . Sat4). By transmitting the data in this way there is a time gap between blocks of data for identical variable types, and whilst the time gap might not appear significant, to the casual observer, for someone who is seriously ill it really is the case that every second counts and as such it would be preferable if an arrangement could be devised that avoided this problem.

To this end it is preferred to interleave the measurements for each variable. For example, as shown in FIG. 10b, in this embodiment the first ECG, Blood Pressure and O₂ saturation measurements are output, following which the second ECG, Blood Pressure and O₂ saturation measurements are output, and so on. The advantage of this arrangement, as compared with the traditional arrangement depicted in FIG. 10, is that there is a much smaller time gap between consecutive measurements for identical variable types, and as such the data displayed on the wearable display is subject to less of a time lag than the arrangement previously proposed.

This functionality can be implemented by configuring the patient monitoring equipment to consecutively output measurements, or by configuring the system hub to reorder received measurements for onward transmission to the wearable computer.

The signals received from the patient monitoring equipment 13, 15 by the hub 11 typically are prefaced with a patient identifier, such as a patient number or bed number, and typically relate to a plurality of different patient vitals.

The clinician can configure the software executed at the hub to select any one or more of the parameters being monitored for a given patient. The hub 11 is also configured to execute a software thresholding module that compares the signals received from the patient monitoring equipment (in particular the values of the vitals being monitored) to thresholds input by a user, typically the clinician charged with looking after that particular patient, which define points where the clinician wishes to be notified about a change in the patient's condition.

As will later be described, the system is configured to provide the wearer of the wearable display with a traffic light display that provides a quick and easy way for the wearer to determine whether the patient's condition has changed, and to this end the thresholds may define vital measurement levels that the clinician feels would be indicative of a significant change in the patients condition. In a particularly preferred arrangement the display is configured to display a green icon for a patient whose vitals have not changed to a significant degree, an amber icon for a patient whose vitals have changed by an amount that is significant but not overly concerning, and a red icon for a patient whose vitals have changed by an amount that might be indicative of a deterioration in the patient's condition. In a particularly preferred arrangement the icons associated with the different thresholds are not only differently coloured, but also displayed in different regions of the wearable display so that any changes in the information display can quickly and readily be appreciated by the wearer of the display.

As an illustrative example a clinician who is monitoring a patient whose resting heart rate is currently 80 bpm, may set a first threshold range to be between 60 bpm and 100 bpm, and a second threshold range to be between 50 and 110 bpm. The effect of this is that whilst the patient's heart rate is above 60 bpm and below 100 bpm, a green icon will be displayed in the wearable display. However, if the patient's heart rate should drop to between 50 and 60 bpm or rise to between 100 and 110 bpm, the green icon will be replaced with an amber icon in the wearable display. Similarly, if the patient's heart rate should drop below 50 bpm or rise above 110 bpm, the amber icon will be replaced with a red icon in the wearable display.

Since it is conceivable that a clinician may wish to monitor a number of variables, the software executed by the hub may be configured to enable combinations of thresholds to be set. Considering the example given above, for a patient who has recently undergone heart surgery, the clinician may wish to monitor the patient's blood pressure in addition to their heart rate.

In one envisaged implementation the clinician may be provided with the opportunity to display more than one icon for each patient. Whilst this arrangement would enable close monitoring of multiple vitals for a given patient, the finite size of the display means that monitoring multiple vitals would reduce the total number of patient's that could be monitored.

To avoid this problem, the clinician is—in the preferred embodiment—provided with the ability to set thresholds that are contingent on a plurality of monitored variables. For example, using the example given above, the clinician may decide that so long as the patient's blood pressure remains between 90 and 110 mmHg, a drop in heart rate to between 50 and 60 bpm or a rise to between 100 and 110 bpm may not be of concern, and configure the system so that an amber icon is not displayed in place of the green icon if the heart rate should drop to between 50 and 60 bpm or rise to between 100 and 110 bpm. Conversely, the clinician may decide that a drop in blood pressure to between 80 and 90 mmHg or a rise to between 110 and 120 mmHg is significant irrespective of whether the heart rate is between 50-60 bpm, 100-110 bpm or 60 to 80 bpm, and configure the hub accordingly.

In general terms the clinician can configure the software so that a threshold is deemed to have been exceeded if one or more or all of the variables being monitored have changed by more than amount that the clinician deems significant.

In one envisaged implementation, the thresholding module may be configured to provide the user with the ability to auto-set thresholds for amber and red icon display. This functionality may be implemented by determining the current measurement value, setting the amber thresholds to be 10% above and below the current measurement value, and setting the red thresholds to be 10% above and below the amber thresholds.

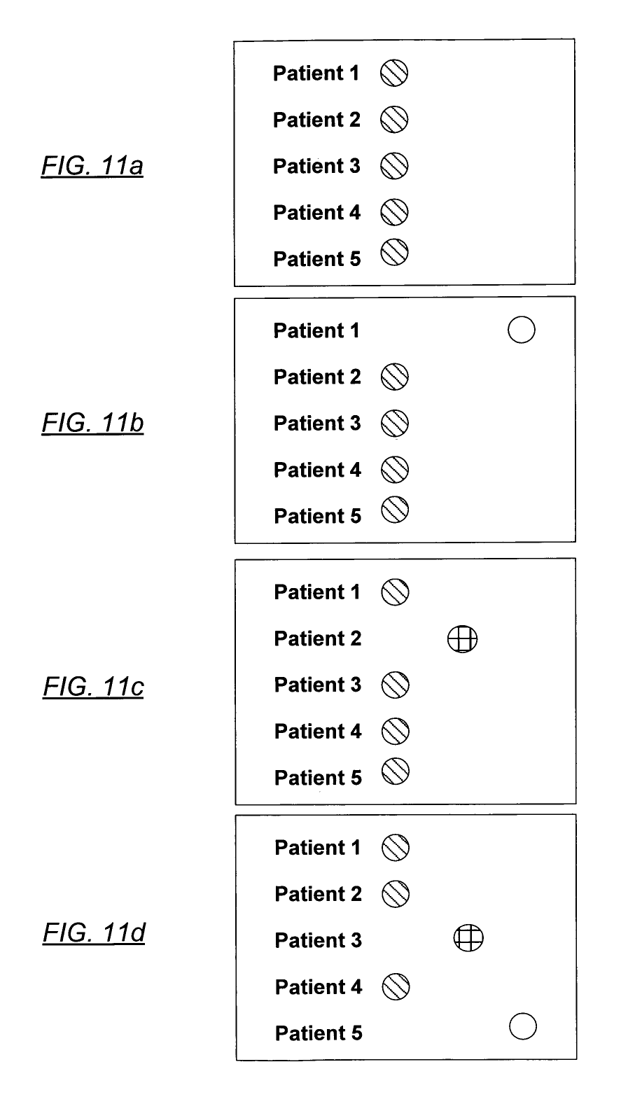

FIGS. 11a to 11d illustrate four representative images displayed on the wearable display. In these figures, “green” icons are shown as circles filled with diagonal lines, amber” icons are shown as circles filled with horizontal and vertical hatching, and “red” icons are shown as unfilled circles. In each displayed image, five different patients (patients 1 to 5) are being monitored.

In FIG. 11a, all five patients have a green icon displayed adjacent their patient identifier. In FIG. 11b, the condition of Patient 1 has deteriorated beyond the threshold set by the clinician that signifies a change of condition that is potentially of concern, and the green icon displayed adjacent Patient 1 in FIG. 11a has been replaced with a red icon (note that both the colour of the icon and the position of the icon on the display have changed). On seeing this display the clinician is immediately aware that a potentially serious change has occurred in Patient 1's condition, and the clinician can immediately and proactively contact the ward without having to wait for the nursing staff to make contact.

In FIG. 11c, Patients 1 and 3 to 5 have a green icon displayed, and Patient 2 has an amber icon displayed adjacent their name. The clinician, on seeing the change to amber, knows that the condition of Patient 2 has changed—perhaps significantly—and can keep an eye on the icons to see if their condition recovers. In FIG. 11d, Patients 1, 2 and 4 are associated with green icons, Patient 3 is associated with an amber icon, and Patient 5 is associated with a red icon.

In the preferred embodiment the data transmitted from the hub is broadcast via the wireless network 9 to enable multiple wearable computers to receive the same data. This is advantageous when a number of clinicians are charged with caring for the same patient. This is implemented by configuring the wearable computers to pick out from the broadcast data only the information that relates to the particular patients that each wearable computer is set up to monitor.

In the preferred arrangement, the system is also configured so that the amount of data transferred via the wireless network to the wearable computers is reduced, and so that security concerns about broadcasting confidential medical data can be avoided. To implement this functionality the system hub comprises a data trimming software module that is configured to trim the data output by the above described thresholding process so that it comprises discrete data blocks that comprise a patient identifier (such as a bed number or a patient ID number), and a status indicator that is equal to 0, 1 or 2—where a zero is interpreted by the wireless computer as an instruction to display a green icon for the patient associated with the transmitted ID number, a one is interpreted by the wireless computer as an instruction to display an amber icon for the patient associated with the transmitted ID number, and a two is interpreted by the wireless computer as an instruction to display a red icon for the patient associated with the transmitted ID number.

By virtue of this arrangement the amount of data transmitted via the wireless network can be greatly reduced, and if the wireless network should be sniffed the information that can be extracted consists only of a string of numbers that does not convey any useful information.

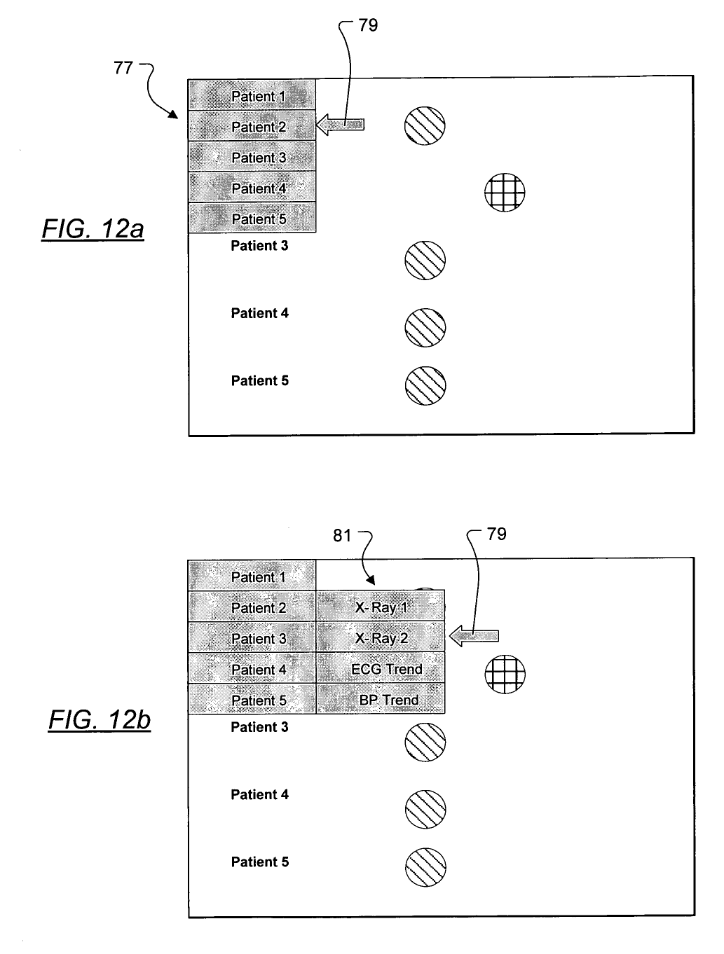

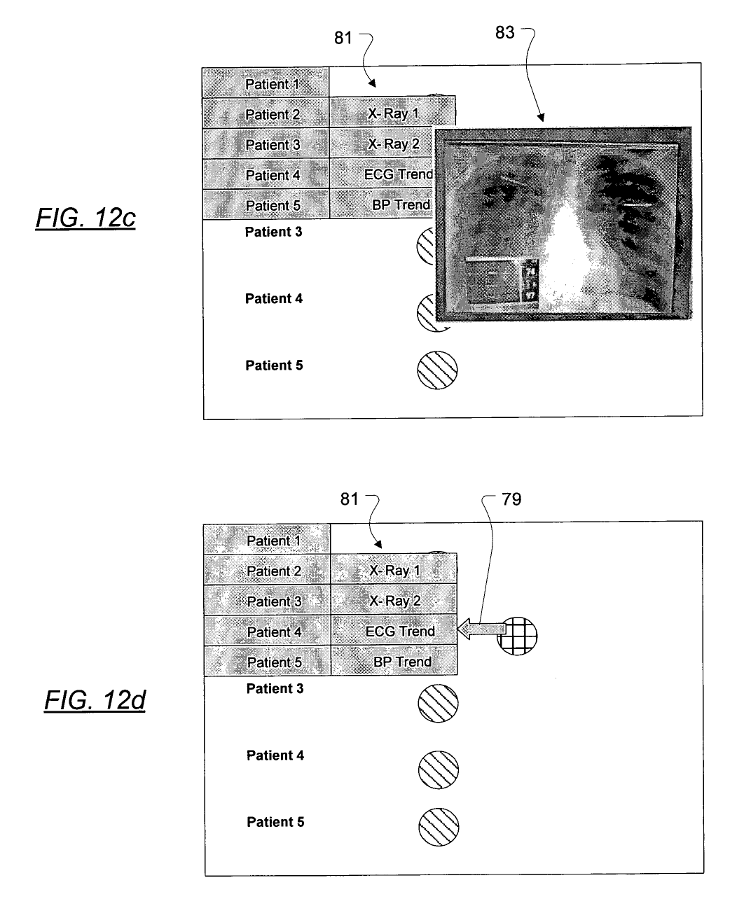

Referring now to FIGS. 12a to 12e, there are depicted representative screenshots from a wearable display that illustrate another aspect of the functionality of the present invention. FIG. 12a corresponds to FIG. 11c aforementioned, and in this instance the user of the wearable computer has decided to try to investigate why the icon associated with Patient 2 has changed from green to amber.

To achieve this, the user operates the control interface to reveal a drop-down menu 77 listing the five patients currently being monitored. In one embodiment the user may activate the drop down menu by moving a pointer 79 using the trackball of the control interface towards the top left-hand corner of the display. In another embodiment the user can activate the drop down menu by speaking an appropriate command (such as “display menu” for example). Once the menu is displayed, as indicated in FIG. 12a, the user can select the patient of interest—in this instance Patient 2—by manipulating the trackball and clicking a trackball button or by saying the patient identifier—in this instance “Patient 2”.

Selection of the patient of interest reveals a further drop-down menu 81, depicted in FIG. 12b, listing items of information associated with that patient. Some of these items of information are identified to the processor of the wearable computer as having previously been stored in the data store 51 of the wearable computer, for example by data transfer from the hub 11 whilst the wearable computer is docked in the docking station 21. In this embodiment others of these items are identified to the processor of the wearable computer as having been stored on the hub or to be streamed directly from the patient monitoring equipment, and the wearable computer may be configured in the event that one of these items is selected, to send a request for transfer of the associated item of information from the hub to the wearable computer via the wireless network 9.

In this instance the user operates the control interface to select option “X-Ray 2”, the processor determines that this is an option that is associated with information that has been stored in the data store 51 of the wearable computer. In response to selection of this option the processor 47 of the wearable computer 3 accesses the data store 51 to retrieve the file (in this instance an X-ray image 83) associated with this option from the data store and displays the retrieved image as shown in FIG. 12c.

In this instance, the user decides that they have finished looking at the retrieved X-ray image 83, and operates the control interface (as shown in FIG. 12d) to revert to the drop-down menu 81. The user then controls the pointer 79 to select another option from the drop-down menu 81, namely the option titled “ECG Trend”. This option is associated with a request for the hub to stream live video to the wearable computer, and in response to selection of this option, the processor 47 sends a request for the file to the hub 11. The processor 27 of the hub 11 then cooperates with the processor of the wearable computer to open a secure wireless data transmission channel (for example an encrypted wireless link) between the hub and the wearable computer via the wireless network 9, and once the channel has been opened the hub streams live video directly from the camera 17 trained on the display of the patient monitoring equipment 15 to the wearable computer. The wearable computer displays the live video stream 85 on the wearable display as shown in FIG. 12e.

In a preferred arrangement the processor of the wearable computer and the processor of the hub may be configured to cooperate to identify whether information retrieved from the hub is likely to change. For information, such as X-rays or test results, that are not likely to change the processor of the wearable computer may be configured to store the data retrieved from the hub in the wearable computer data store so that any subsequent requests for that information can be fulfilled without having to reload the information. Conversely, if the information is identified as being likely to change (for example if it is a live video stream), the processor of the wearable computer may be instructed not to store it in the data store of the wearable computer.

It will be apparent from the foregoing illustrative discussion, that the system of the present invention provides users of the wearable computer with the ability to “drill down” into the information displayed on the wearable display so that other information items of relevance to the patient status information displayed on the display can be reviewed.

In the preferred embodiment, the system of the present invention is also configured to enable messages to be sent to users of the wearable computers. For example, in circumstances where new test results or X-Ray images for a given patient are obtained, it is advantageous to be able to contact the users interested in the wellbeing of that patient to advise them that additional information is available. This functionality may be provided by uploading new information to the data store 33 in association with a particular patient identifier, and broadcasting a message via the wireless network which includes the patient identifier and a signal indicating that new information is available. Those wearable computers that are configured to monitor the particular patient identifier included in the message receive the embedded signal and notify the user (for example by displaying a message on the screen or sounding an alarm) that new information is available for download from the hub. In a particularly preferred embodiment, the message may also include an indication of what the new information relates to, and the wearable computer may be configured to add this indication to the drop down menu for that patient so that the user of the wearable computer can determine whether they need to look at the new information simply by looking at the drop-down menu.

In a highly preferred embodiment, access to the wearable computers is controlled so that only authorised persons can use them. This functionality could be implemented by requiring the user to enter a password before the wearable computer can be used. Alternatively or additionally, the wearable computer may include a smart card reader or a biometric sensor (such as a fingerprint sensor) that is configured to prevent access to the wearable computer until a verified smart card has been inserted or the user's fingerprint has been validated.

Much of the functionality herein described is implemented in software, but it will be appreciated by persons skilled in the art that some or all of this functionality could alternatively be implemented in hardware (for example by means of one or more application specific integrated circuits (ASICs)) or by means of a combination of hardware and software. As such, the scope of the present invention should not be interpreted as being limited only to being implemented in software.

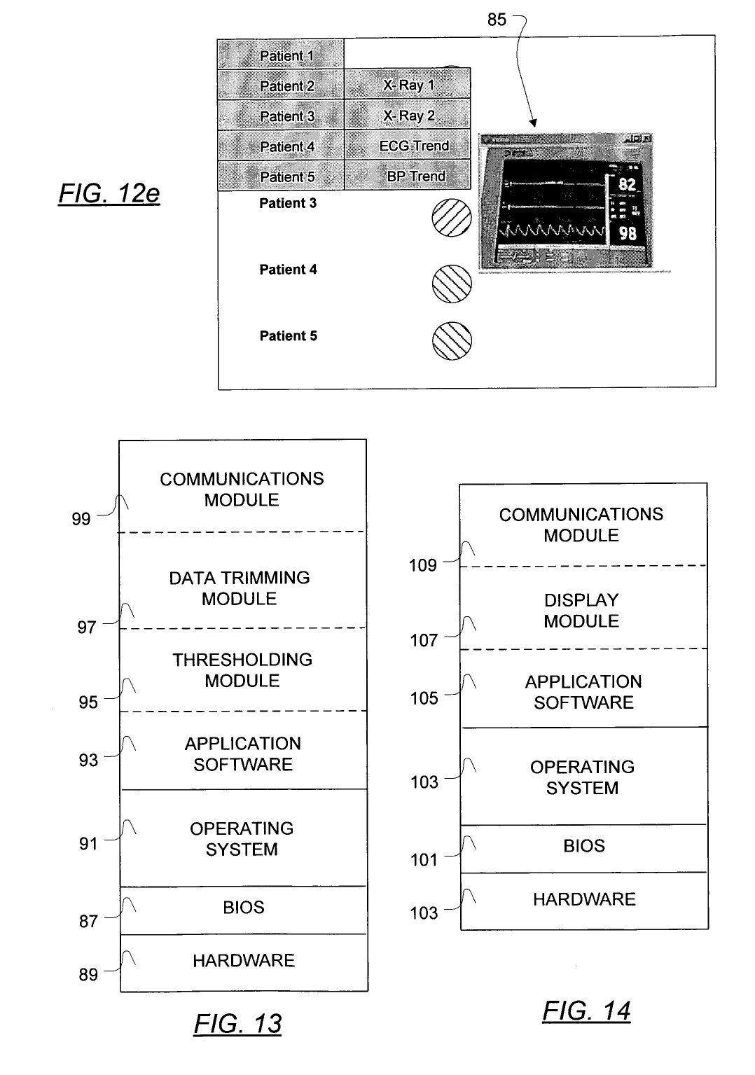

Referring now to FIG. 13, in the preferred arrangement the hub processor 27 and hub memory 31 cooperate to establish a BIOS (Basic Input/Output System) 87 that functions as an interface between the functional hardware components 89 of the system hub and the software executed by the hub. The processor then loads from memory 31 an operating system 91 which provides an environment in which application software 93 (implementing some or all of the abovedescribed functionality) can run. In accordance with the preferred embodiment of the present invention, part of this functionality is provided by a thresholding module 95, a data trimming module 97 and a wireless communications module 99, the functions of which have been outlined above.

Referring now to FIG. 14 in the preferred arrangement the wearable computer processor 47 and memory 49 cooperate to establish a BIOS (Basic Input/Output System) 101 that functions as an interface between the functional hardware components 103 of the wearable computer and the software executed thereby. The processor 47 then loads from memory 49 an operating system 103 which provides an environment in which application software 105 (implementing some or all of the abovedescribed functionality) can run. In accordance with the preferred embodiment of the present invention, part of this functionality is provided by a display module 107 and a wireless communications module 109, the functions of which have been outlined above. In a particularly preferred implementation that reduces the processing load for the wearable computer the application software may be written in Java™ and the operating system may comprise Linux™. The application software for the system hub may also be written in Java™.

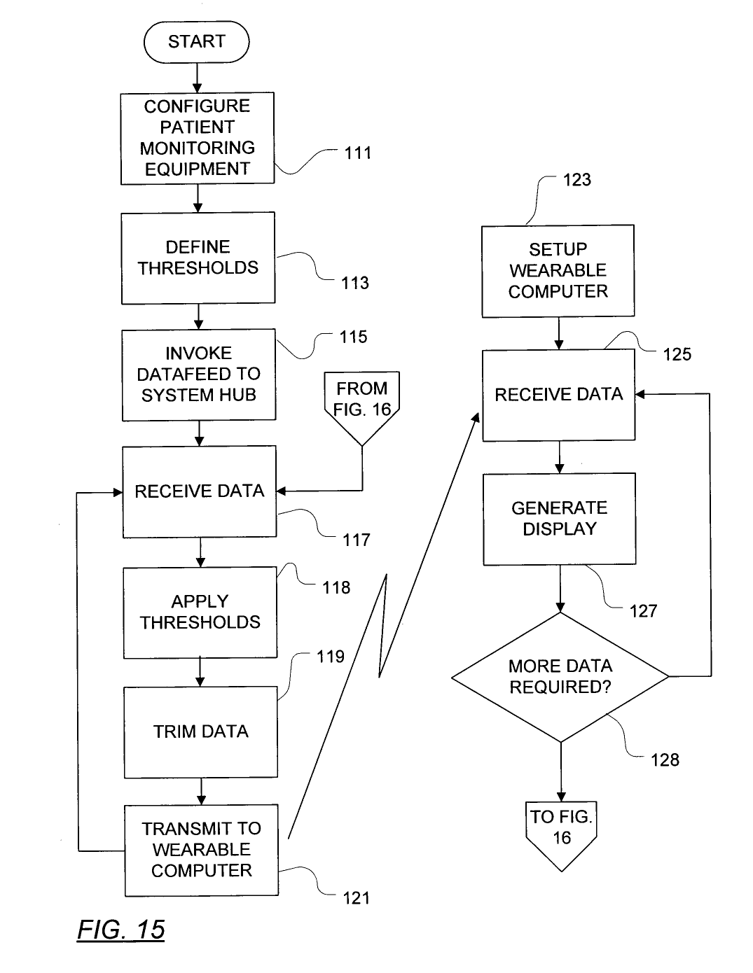

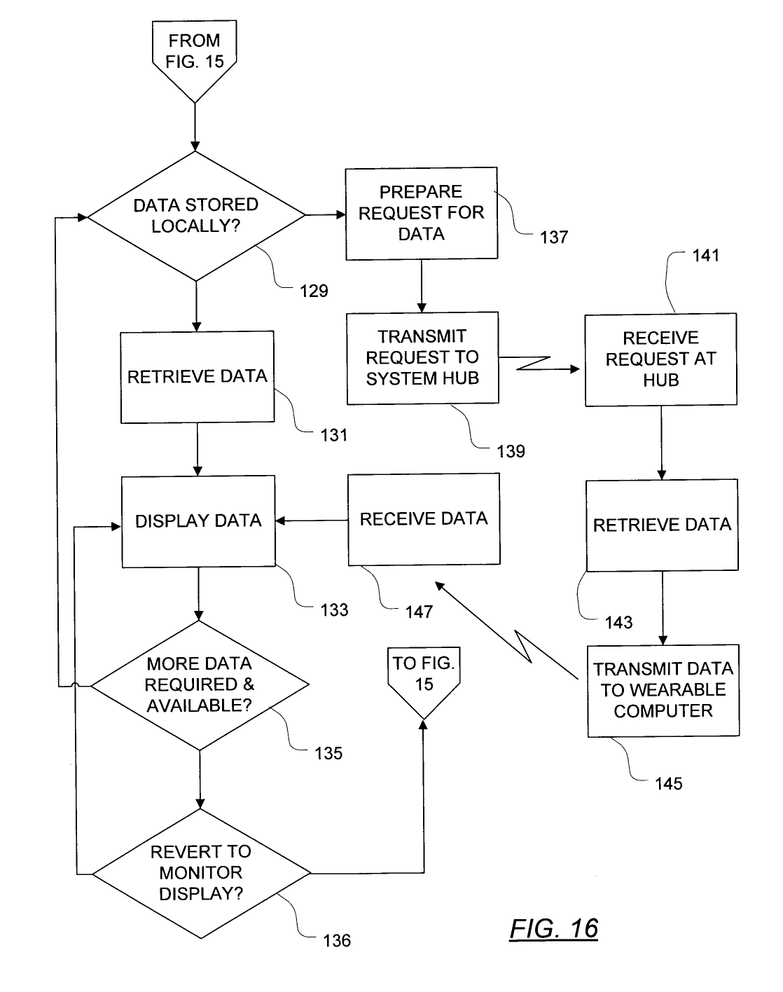

An overview of the operation of the system will now be provided with reference to FIGS. 15 and 16. In a first step 111, the patient monitoring equipment is configured to monitor the patient vitals of interest to the clinician. Next in step 113 the clinician defines the thresholds for the vitals of interest, following which monitoring begins in step 115 and data is fed to the system hub. Data received by the system hub in step 117 is thresholded in step 118 and trimmed in step 119, following which it is transmitted in step 121 to the wearable computer in the form, previously described, of a 0, a 1 or a 2. Processing then reverts to step 117.

The wearable computer is set up in step 123 to include details of the patients of interest and to transfer any relevant information from the hub to the wearable computer. The wearable computer then receives data from the hub in step 125, and generates a display for display on the wearable display in step 127. If the user should indicate in step 128 that more data is required, processing moves to FIG. 16, otherwise it reverts to step 125.

Referring now to FIG. 16, if further data should be required a check is made in step 129 to determine whether the required data is stored locally. If the data required is stored locally, it is retrieved in step 131, and displayed in step 133. Next a determination is made as to whether further information is required and available in step 135. If more data should be required and is available, processing reverts to step 129. If more data should not be required, a determination is made in step 136 whether the user wishes to revert to display of the monitored patient vitals and processing reverts to step 125 of FIG. 15.

If further information should be required and it is not stored locally, a request for data is prepared in step 137 and transmitted to the system hub in step 139. The system hub receives the request in step 141, retrieves the requested data in step 143, and transmits the data to the wearable computer in step 145. The system hub receives the transmitted data in step 147, and processing reverts to step 133.

It will be appreciated from the foregoing that the teachings of the present invention provide an effective means to avoid or at least reduce the problems hereindescribed. It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst the preferred embodiment has been described herein with particular reference to the application of the teachings of the invention to a hospital environment, it should be noted that this is merely illustrative and that the teachings of the present invention may be otherwise applied. For example, the teachings of the present invention could usefully be employed in any sort of monitoring situation where it is necessary to be aware of a number of variables whilst undertaking a given task. For example in a nuclear power station it may be advantageous, whilst undertaking maintenance work on a particular component, to be aware of the operating status of other components of the installation. The teachings of the present invention could also usefully be employed in competitive racing, for example in Formula 1, where it is often necessary to monitor many different variables and combinations of variables to ensure that the vehicle is operating to its fullest potential. By applying the teachings of the present invention a person monitoring the vehicle could be provided with an early warning of any developing problems with the vehicle. Many other suitable applications will be apparent to persons of ordinary skill in the art.

Lastly, It should also be noted that whilst the accompanying claims set out particular combinations of features described herein, the scope of the present invention is not limited to the particular combinations hereafter claimed, but instead extends to encompass any combination of features herein disclosed.

1. A computer system comprising:
a system hub configured to receive data signals from one or more items of equipment, and to generate signals for transmission to a wearable computer from said received data signals;
a wearable display; and
a wearable computer configured to receive the signals transmitted from said system hub, and to display on said wearable display information relating to the signals received from said system hub.

2. A computer system according to claim 1, wherein the data signals from the one or more items of equipment are each indicative of at least one measured parameter.

3. A computer system according to claim 2, wherein the system hub comprises a thresholding module configured to determine whether the measured parameters transgress one or more thresholds.

4-7. (canceled)

8. A computer system according to claim 3, wherein said system hub comprises a trimming module configured to output said signals for transmission to said wearable computer, wherein said trimming module is responsive to said thresholding module and said signals vary in dependence upon whether and/or which of said thresholds are determined to be transgressed.

9. A computer system according to claim 8, wherein said signals output by said trimming module comprise an indicator.

10. A computer system according to claim 9, wherein said wearable computer comprises a display module that is configured to extract said indicator from said signals output by said trimming module and transmitted to said wearable computer.

11. A computer system according to claim 10, wherein said display module is responsive to said indicator to select information for display on said wearable display.

12-15. (canceled)

16. A computer system according to claim 9, wherein said signals output by said trimming module comprise an identifier.

17. A computer system according to claim 16, wherein each said identifier associates the accompanying indicator with an item of equipment from which signals are received by said system hub

18. (canceled)

19. A computer system according to claim 1, wherein a said item of equipment comprises a camera.

20. A computer system according to claim 19, wherein said camera is trained on a display of another item of equipment and configured to capture an image of information displayed on the display of said other item of equipment.

21-25. (canceled)

26. A computer system according to claim 1, wherein said data signals relate to a plurality of parameters monitored by one item of equipment, and components of said data signals relating to respective monitored parameters are arranged so that monitored parameter components are interleaved with one another.

27-38. (canceled)

39. A computer system according to claim 1, wherein said wearable display comprises a head mounted display.

40. A method comprising:
operating one or more items of equipment to generate data signals;
transmitting said data signals to a system hub that is configured to receive said data signals, and from said received data signals to generate signals for transmission to a wearable computer; and
operating a wearable computer to receive the signals transmitted from said system hub, and to generate from said signals transmitted from said system hub information for display on a wearable display that relates to the signals received from said system hub.

41. A method according to claim 40, comprising the step of operating the system hub to compare said received data signals to one or more thresholds, wherein the signals generated for transmission to said wearable computer indicate whether and/or which of said thresholds have been transgressed.

42. A method according to claim 41, comprising the step of operating the wearable computer to generate information for display on said wearable display that provides an indication of indicate whether and/or which of said thresholds have been transgressed.

43. (canceled)

44. (canceled)

45. A method according to claim 42, comprising the step of operating the wearable computer to select one of a plurality of selectable locations on said wearable display for display of said icon, wherein the selected display location conveys an indication of whether and/or which threshold has been transgressed.

46. A method according to claim 45, configured to enable remote monitoring of said items of equipment via the information displayed on said wearable display.

47. A method according to claim 46, wherein a said item of equipment comprises patient monitoring equipment configured to monitor the wellbeing of a patient, and the information displayed on said wearable display conveys information regarding the wellbeing of that patient.

48. A method according to claim 46, wherein a said item of equipment comprises a camera trained on a display of patient monitoring equipment that is configured to monitor the wellbeing of a patient, the camera is configured to capture an image of said display, and the information displayed on said wearable display conveys information regarding the wellbeing of that patient.

49-54. (canceled)
